(19) United States
(12) Patent Application Publication
(10) Pub. No.: US 2026/0132902 A1
(43) Pub. Date: May 14, 2026

(54) VEHICLE LAMP

(71) Applicant: HYUNDAI MOBIS CO., LTD., Seoul (KR)

(72) Inventor: Hyun Chang HWANG, Yongin-si (KR)

(73) Assignee: HYUNDAI MOBIS CO., LTD., Seoul (KR)

(21) Appl. No.: 19/270,625

(22) Filed: Jul. 16, 2025

(30) Foreign Application Priority Data
Nov. 8, 2024 (KR) 10-2024-0158359

(51) Int. Cl. F21S 41/63; F21S 41/20; F21S 41/663; G02B 26/08

(52) U.S. Cl. CPC F21S 41/635; F21S 41/285; F21S 41/663; G02B 26/0875

(57) ABSTRACT

A vehicle lamp including a light source part that generates light and a lens assembly including a plurality of lens modules that are provided to form a light distribution pattern by emitting the light radiated from the light source part to the front and that are individually rotated and driven. The lens assembly is provided to form a plurality of light distribution patterns having different characteristics by the individual rotation driving of the plurality of lens modules.

### CROSS-REFERENCE TO RELATED APPLICATION

This application claims the benefit of priority to Korean Patent Application No. 10-2024-0158359, filed in the Korean Intellectual Property Office on November 8, 2024, the entire contents of which are incorporated herein by reference.

### TECHNICAL FIELD

The present disclosure relates to a vehicle lamp.

### BACKGROUND

In general, vehicles are provided with various types of lamps having a lighting function for easily identifying an object located around a vehicle during night traveling and a signal function for notifying other vehicles or road users of a traveling state of the vehicle.

Examples of vehicle lamps include head lamps (headlights) and fog lamps mainly for the purpose of lighting functions and turn signal lamps, tail lamps, brake lamps, side markers and the like for the purpose of signal functions, and installation standards and specifications of these vehicle lamps are regulated by laws so that the respective functions are fully exhibited.

Among the vehicle lamps, a head lamp, which forms a low-beam pattern or a high-beam pattern to ensure a front view of a driver during night driving, plays a very important role in safe driving.

Meanwhile, performance of the head lamp is important, but external designs of the head lamp and a light distribution pattern are also important. Recently, a design aspect has been emphasized using a surface-light emitting type lamp. However, due to the nature of the head lamp that performs various functions, the surface-light emitting lamp has limitations in performing various functions.

### SUMMARY

The present disclosure has been made to solve the above-mentioned problems occurring in the prior art while advantages achieved by the prior art are maintained intact.

An aspect of the present disclosure provides a lamp that performs various functions even without an additional separate lamp. A vehicle lamp is provided.

Another aspect of the present disclosure provides a vehicle lamp, which implements a lamp that performs various functions, such as a daytime running lamp, a low beam and high beam lamp, an adaptive driving beam, and a turn signal lamp, with a single vehicle lamp.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a vehicle lamp includes a light source part that generates light and a lens assembly including a plurality of lens modules configured to form a light distribution pattern by emitting the light radiated from the light source part to the front, the lens modules being individually rotated and driven, wherein the lens assembly is configured to form a plurality of light distribution patterns having different characteristics by individual rotation driving of the plurality of lens modules.

The plurality of lens modules may be arranged in a lattice form that is repeated in a vertical direction and a horizontal direction.

Each of the lens modules may include a lens part and an optic part including a plurality of optics disposed on a surface of the lens part and having different optical characteristics.

The lens part may include a micro lens and a pair of rotary shafts protruding from a pair of surfaces of the micro lens, which face each other, and the optic part may be disposed on a surface of the micro lens other than a surface from which the rotary shaft protrudes among outer surfaces of the micro lens.

The micro lenses adjacent to each other may share an imaginary central axis extending in a vertical direction or a horizontal direction, the rotary shafts may be formed on the imaginary central axis, and the optic part may surround an outer surface spaced apart from the imaginary central axis in a radial direction, among the outer surfaces of the micro lens.

The micro lens may have a hexahedral shape and may include a pair of rotary shaft surfaces from which the rotary shafts protrude and which face each other, a first incidence surface that connects the pair of rotary shaft surfaces and on which light is incident, a first emission surface facing the first incidence surface, a second incidence surface that connects the pair of rotary shaft surfaces and on which light is incident, and a second emission surface facing the second incidence surface.

The optic part may include a first optic installed on the first incidence surface and the first emission surface and a second optic installed on the second incidence surface and the second emission surface.

Each of the plurality of lens modules may allow the light emitted from the light source part to selectively pass through any one of the first optic and the second optic by rotation, and a light distribution pattern generated by the light passing through the first optic and a light distribution pattern generated by the light passing through the second optic may have different characteristics.

The first optic may include a (1-1)^{th} optic installed on the first incidence surface and a (1-2)^{th} optic installed on the first emission surface, and the second optic may include a (2-1)^{th} optic installed on the second incidence surface and a (2-2)^{th} optic installed on the second emission surface.

Each of the plurality of lens modules may further include a rotation unit that rotates the corresponding lens module.

The rotation unit may include a support member that rotatably supports the lens part, a driving member that provides a driving force for rotating the lens part, and a controller that controls the driving member so that the plurality of lens modules are individually rotated and driven.

One of the pair of rotary shafts protruding from the rotary shaft surfaces of the micro lens may be rotatably installed in the support member, and the other one thereof may be coupled to the driving member and configured to receive a rotational force.

The support member disposed in one of the lens modules adjacent to each other may be coupled to the driving member disposed in the other adjacent lens module.

The support member may have a shaft groove into which an end of the rotary shaft is inserted.

The driving member may include a piezo actuator.

The plurality of lens modules may be divided into a first area, a second area disposed under the first area, and a third area disposed under the second area, the lens assembly may be switched to any one of a first mode, a second mode, and a third mode, the first mode may be a mode in which light incident on the lens module in the first area, the second area, and the third area passes through the second optic, and a daytime running lamp pattern is formed by light emitted from the lens assembly, the second mode may be a mode in which light incident on the lens module in the first area passes through the second optic, light incident on the lens module in the second area and the third area passes through the first optic, and a low beam pattern is formed by the light emitted from the lens assembly, and the third mode may be a mode in which the light incident on the lens module in the first area, the second area, and the third area passes through the first optic, and a high beam pattern is formed by the light emitted from the lens assembly.

The vehicle lamp may further include an object sensing part that senses an object present in front of a vehicle, wherein, when receiving a sensing signal generated by sensing the object from the object sensing part, the controller may be configured to control the driving member so that light incident on the lens module in an area corresponding to the object passes through the second optic, and light incident on the lens module in the other area passes through the first optic.

The light source part may be color-switchable.

### BRIEF DESCRIPTION OF THE DRAWINGS

The above and other objects, features and advantages of the present disclosure will be more apparent from the following detailed description taken in conjunction with the accompanying drawings:

FIG. 1 is a perspective view illustrating a vehicle lamp according to an embodiment of the present disclosure;

FIG. 2 is a perspective view illustrating a lens part and a rotation controller of an individual lens module according to the embodiment of the present disclosure;

FIG. 3 is a perspective view illustrating the lens part and an optic part of the individual lens module according to the embodiment of the present disclosure;

FIG. 4 is a perspective view illustrating a rotation unit according to the embodiment of the present disclosure;

FIG. 5 is a perspective view illustrating the rotation unit according to the embodiment of the present disclosure and is a view when viewed in a rear direction of FIG. 3;

FIG. 6A is a schematic view of the vehicle lamp according to the embodiment of the present disclosure, is a side view when viewed from a lateral side, and is a view illustrating a state of being switched to a first mode for forming a daytime running lamp pattern;

FIG. 6B is a schematic view of the vehicle lamp according to the embodiment of the present disclosure, is a side view when viewed from a lateral side, and is a view illustrating a state of being switched to a second mode for forming a low beam pattern;

FIG. 6C is a schematic view of the vehicle lamp according to the embodiment of the present disclosure, is a side view when viewed from a lateral side, and is a view illustrating a state of being switched to a third mode for forming a high beam pattern;

FIG. 7A is a perspective view illustrating the vehicle lamp according to the embodiment of the present disclosure and is a view illustrating a state in which all areas of a lens module are switched to transmit a second optic; and

FIG. 7B is an upper view and a lower view illustrating a state in which light is switched to pass through a first optic or the second optic according to a location of an object present on a front side.

### DETAILED DESCRIPTION

Hereinafter, embodiments of the present disclosure will be described in detail with reference to the accompanying drawings.

First, the embodiments described below are embodiments suitable for understanding technical features of a vehicle lamp according to the present disclosure. However, the present disclosure is not limited to the embodiments described below, the technical features of the present disclosure are not limited by the described embodiments, and various modifications may be made within the technical scope of the present disclosure.

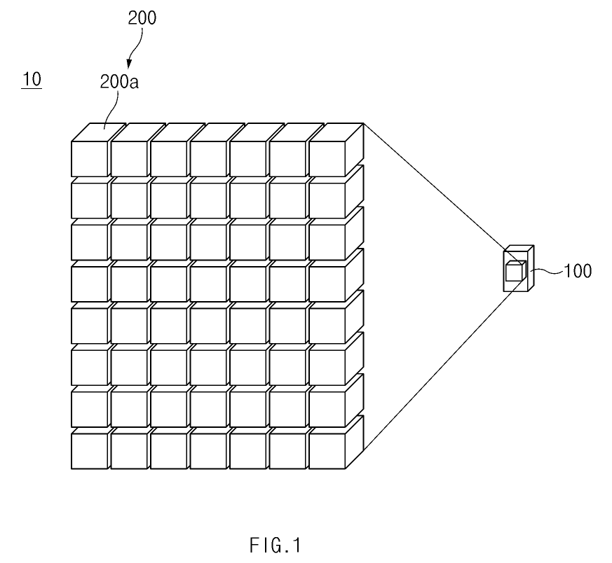

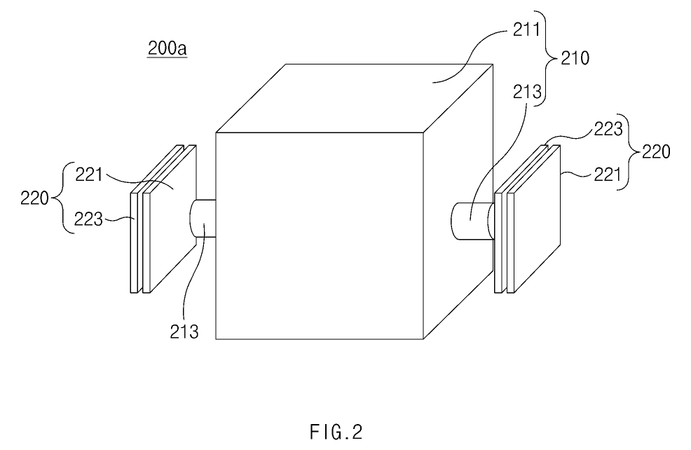

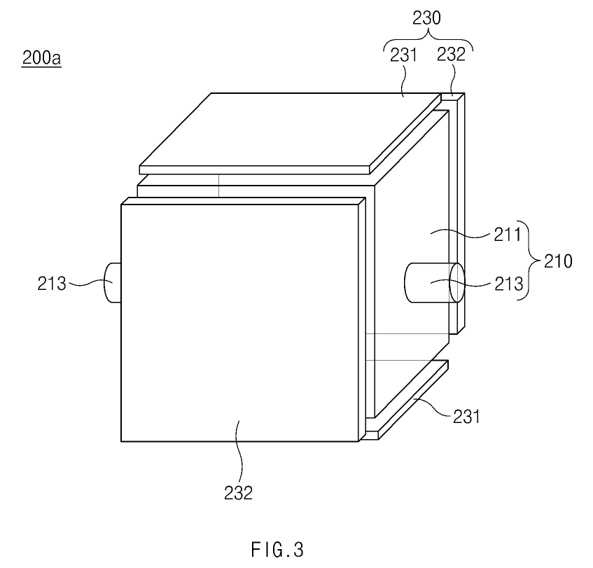

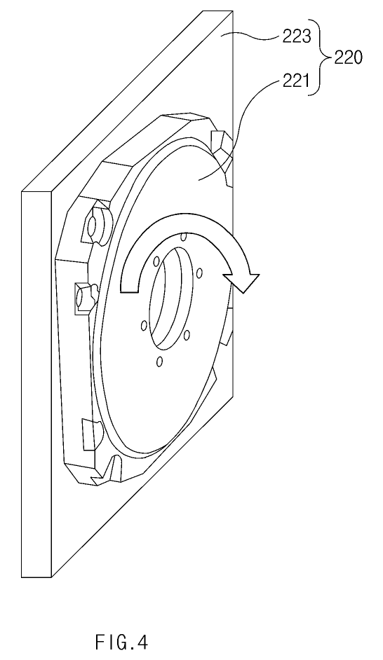

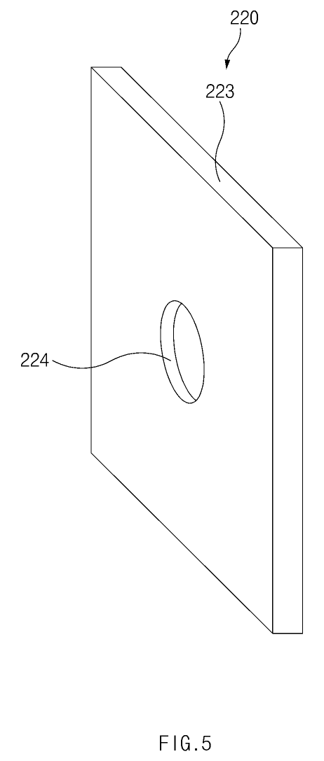

FIG. 1 is a perspective view illustrating a vehicle lamp according to an embodiment of the present disclosure, FIG. 2 is a perspective view illustrating a lens part and a rotation controller of an individual lens module according to the embodiment of the present disclosure, FIG. 3 is a perspective view illustrating the lens part and an optic part of the individual lens module according to the embodiment of the present disclosure, FIG. 4 is a perspective view illustrating a rotation unit according to the embodiment of the present disclosure, and FIG. 5 is a perspective view illustrating the rotation unit according to the embodiment of the present disclosure and is a view when viewed in a rear direction of FIG. 3.

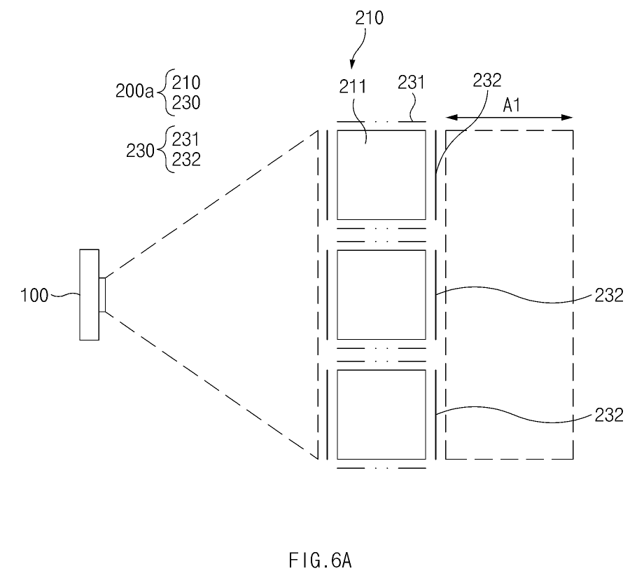

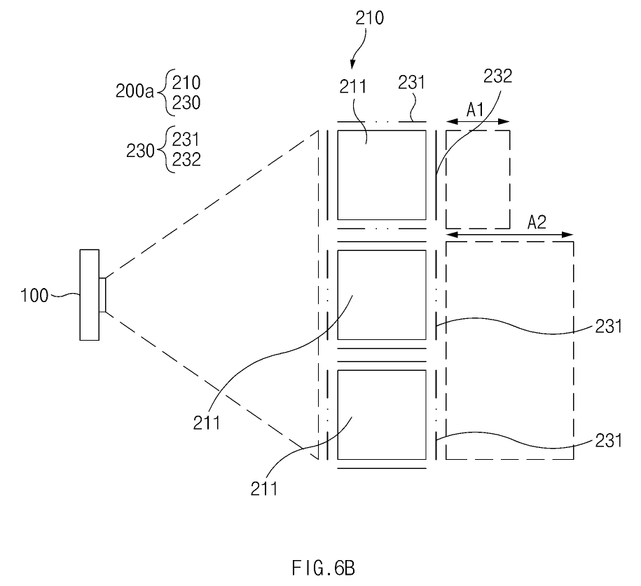

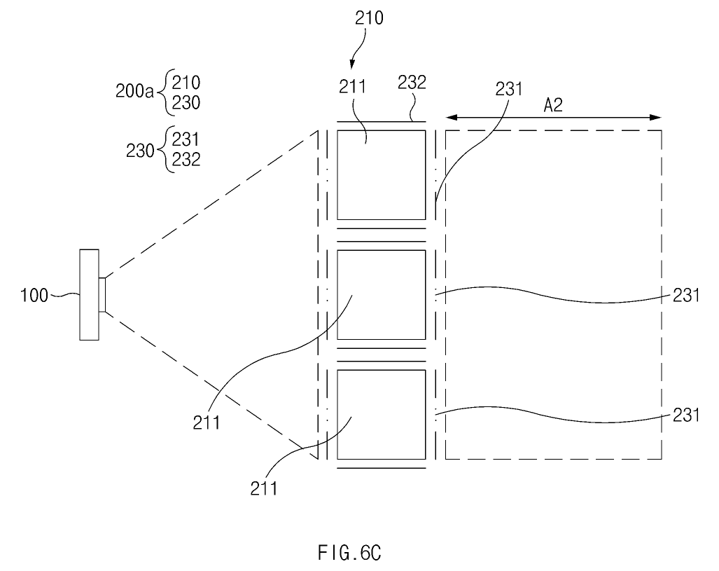

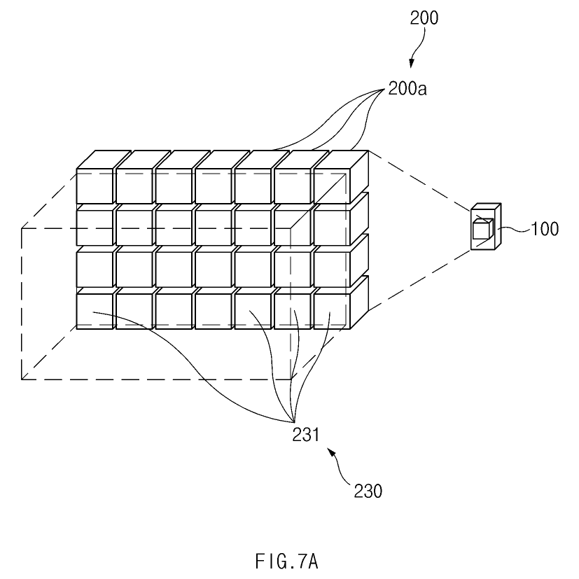

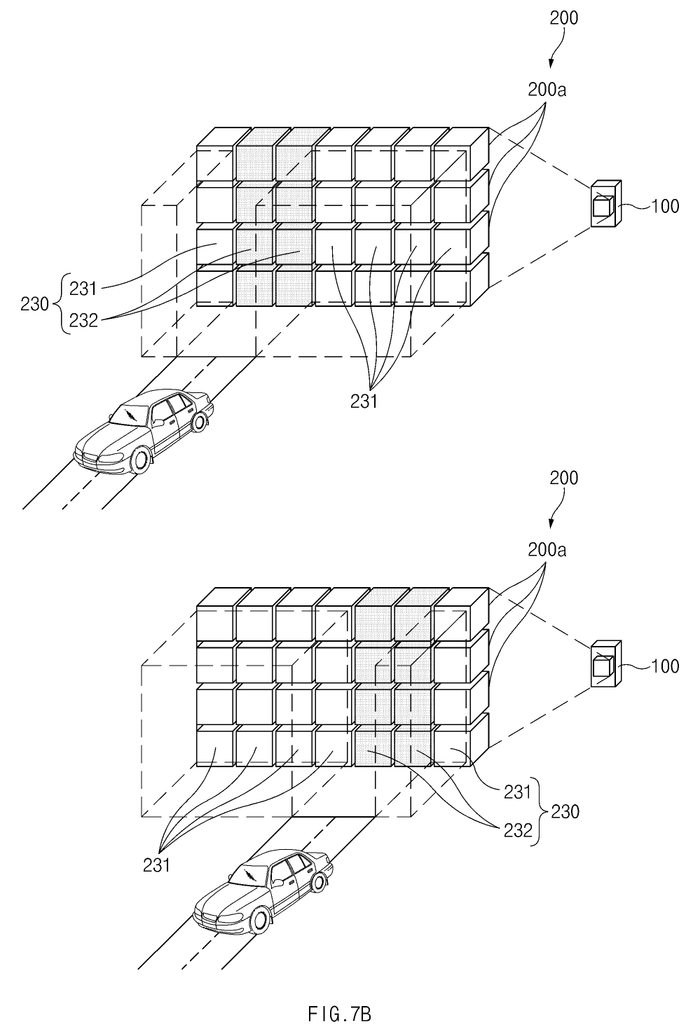

FIG. 6A is a schematic view of the vehicle lamp according to the embodiment of the present disclosure, is a side view when viewed from a lateral side, and is a view illustrating a state of being switched to a first mode for forming a daytime running lamp pattern, FIG. 6B is a schematic view of the vehicle lamp according to the embodiment of the present disclosure, is a side view when viewed from a lateral side, and is a view illustrating a state of being switched to a second mode for forming a low beam pattern, FIG. 6C is a schematic view of the vehicle lamp according to the embodiment of the present disclosure, is a side view when viewed from a lateral side, and is a view illustrating a state of being switched to a third mode for forming a high beam pattern, FIG. 7A is a perspective view illustrating the vehicle lamp according to the embodiment of the present disclosure and is a view illustrating a state in which all areas of a lens module are switched to transmit a second optic, and FIG. 7B is an upper view and a lower view illustrating a state in which light is switched to pass through a first optic or the second optic according to a location of an object present on a front side.

Referring to FIGS. 1 to 7B, a vehicle lamp 10 according to an embodiment of the present disclosure includes a light source part 100 and a lens assembly 200.

The light source part 100 is provided to generate light.

For example, the light source part 100 may be provided as a light emitting diode (hereinafter, referred to as an LED). Further, the light source part 100 may include a substrate and a light source mounted on the substrate.

The lens assembly 200 may be provided to emit light radiated from the light source part 100 to the front to form a light distribution pattern and may include a plurality of lens modules 200a that individually rotates and drives.

In detail, the lens assembly 200 may serve as an emission lens that emits light to form a predetermined light distribution pattern. The light distribution pattern formed by the lens assembly 200 may be various patterns such as a daytime running lamp pattern, a low beam pattern, a high beam pattern, and a direction indication pattern.

The lens assembly 200 may include the plurality of lens modules 200a, and the plurality of lens modules 200a may be arranged such that an emission surface faces the front. Further, each of the plurality of lens modules 200a may be controlled to be individually rotated and driven.

There is no limitation on arrangement of the plurality of lens modules 200a and the plurality of lens modules 200a may be modified in various arrangements. For example, the plurality of lens modules 200a may be arranged in a lattice shape that is repeated in a vertical direction and a horizontal direction. Further, for example, the plurality of lens modules 200a may be provided in a similar shape and repeatedly arranged.

Further, the lens assembly 200 is provided to form a plurality of light distribution patterns having different characteristics by the individual rotation driving of the plurality of lens modules 200a.

In detail, in the embodiment of the present disclosure, as in the illustrated embodiment, the plurality of lens modules 200a may be arranged on the same imaginary plane to emit light and thus may be implemented as a surface-light emitting type lamp. A head lamp may form various light distribution patterns as described above, and according to the recent trend of favoring a slim lamp, a lamp that performs various functions (implements light distribution patterns) with a minimum lamp structure is required.

In the embodiment of the present disclosure, a lamp, which performs various functions without an additional separate lamp as the plurality of lens modules 200a implemented as a surface-light emitting type are individually rotated and driven, may be implemented. That is, in the embodiment of the present disclosure, various light distribution patterns may be formed according to rotation states of the lens modules 200a.

For example, according to the embodiment of the present disclosure, a lamp, which performs various functions, such as a daytime running lamp (DRL), a low beam and a high beam lamp, an adaptive driving beam (ADB), and a turn signal lamp may be implemented as the one vehicle lamp 10.

Further, according to the embodiment of the present disclosure, one lamp structure may implement a plurality of functions, and thus use of an additional lamp is not required.

In more detail, each of the lens modules 200a may include a lens part 210 and an optic part 230.

The lens part 210 may be provided to be rotatable. An emission surface and an incidence surface may be changed depending on the rotation of the lens part 210.

The optic part 230 may include a plurality of optics provided on a surface of the lens part 210 and having different optical characteristics.

In detail, a light distribution pattern of each of the lens modules 200a may be changed by the optic part 230 provided on the incidence surface and the emission surface, and the lens modules 200a may implement various light distribution patterns as the optic part 230 forming the emission surface and the incidence surface is switched by the rotation of the lens part 210.

As an example, the optical characteristics of each of the plurality of optics may be determined as a focal length of the optic. A projection surface may be different according to radiation angles of the optics, and accordingly, a radiation distance, a light concentration, and the like of light may be different according to angles of the plurality of optics.

However, the optical characteristics of each of the optics are not limited to the above, and as an example, various optical characteristics such as a magnification and an aberration may be applied.

The lens part 210 may include a micro lens 211 and a pair of rotary shafts 213.

The micro lens 211 may include a plurality of surfaces. Further, the rotary shafts 213 may protrude from a pair of surfaces of the micro lens 211, facing each other, and may be provided as a pair of rotary shafts 213.

For example, the micro lens 211 may be formed in a hexahedral shape. The rotary shafts 213 may protrude from a pair of surfaces facing each other among six surfaces of the micro lens 211 and may be arranged on an imaginary central axis. Further, for example, the rotary shafts 213 provided in the micro lenses 211 adjacent to each other may be arranged on the same axis.

Further, the optic part 230 may be provided on a surface other than a surface from which the rotary shaft 213 protrudes among outer surfaces of the micro lens 211.

In more detail, the micro lenses 211 adjacent to each other may share an imaginary central axis extending in a vertical direction or a horizontal direction. Further, the rotary shafts 213 may be formed on the central axis.

For example, an example in which the imaginary central axis extends in a horizontal direction is illustrated in the illustrated drawing. However, the present disclosure is not limited thereto, the imaginary central axis may extend in a vertical direction, and accordingly, the micro lenses 211 adjacent to each other in a vertical direction based on the illustrated drawing may have the same rotation direction.

The optic part 230 may be provided to surround an outer surface spaced apart from the imaginary central axis in a radial direction among the outer surfaces of the micro lens 211. For example, when the micro lens 211 has a hexahedral shape, the optic parts 230 may be installed on four surfaces except for surfaces on which the rotary shafts 213 are formed.

In more detail, the micro lens 211 may include a pair of rotary shaft surfaces from which the rotary shafts 213 protrude and which face each other, a first incidence surface which connects the pair of rotary shaft surfaces and on which light is incident, and a first emission surface that is a surface facing the first incidence surface.

Further, the micro lens 211 may further include a second incidence surface which connects the pair of rotary shaft surfaces and is a surface on which light is incident and a second emission surface that is a surface facing the second incidence surface.

For example, the lens module 200a may be provided to rotate about the rotary shaft 213 by 90 degrees, and during the rotation, light may pass through the first incidence surface and the first emission surface or light may pass through the second incidence surface and the second emission surface.

Meanwhile, the optic part 230 may include a first optic 231 and a second optic 232.

The first optic 231 may be installed on the first incidence surface and the first emission surface. Further, the second optic 232 may be installed on the second incidence surface and the second emission surface.

Further, each of the plurality of lens modules 200a may be provided such that light emitted from the light source part 100 selectively passes through any one of the first optic 231 and the second optic 232 due to the rotation.

Here, a light distribution pattern generated by light passing through the first optic 231 and a light distribution pattern generated by light passing through the second optic 232 may have different characteristics.

In detail, as described above, the first optic 231 and the second optic 232 may have different optical characteristics. For example, the first optic 231 and the second optic 232 may have different focal lengths. The first optic 231 and the second optic 232 may have different shapes of emission surfaces or incidence surfaces, accordingly, may have different focal lengths, and different refraction and diffusion of light, and thus may form light distribution patterns having different characteristics.

For example, each of the first optic 231 and the second optic 232 may include a pair of optics facing each other. In detail, the first optic 231 may include a (1-1)^{th} optic installed on the first incidence surface and a (1-2)th optic installed on the first emission surface.

Further, the second optic 232 may include a (2-1)^{th} optic installed on the second incidence surface and a (2-2)^{th} optic installed on the second emission surface.

Meanwhile, hereinafter, a rotation unit 220 will be described in detail with reference to FIGS. 2 to 5.

Each of a plurality of lens modules 200a may further include the rotation unit 220 for rotating the corresponding lens module 200a.

In detail, the rotation unit 220 may include a support member 223, a driving member 221, and a controller.

The support member 223 may rotatably support the lens part 210. Further, the driving member 221 may provide a driving force for rotating the lens part 210.

For example, the support member 223 may be formed in a plate shape as in the illustrated embodiment and may be installed to be perpendicular to the rotary shaft 213. The support member 223 may rotatably support the lens part 210 as the rotary shaft 213 of the lens part 210 is rotatably coupled to the support member 223.

The driving member 221 may provide a driving force capable of rotating the lens part 210. The driving member 221 may control the lens part 210 such that the lens part 210 rotates at a set angle.

For example, the driving member 221 may include a piezo actuator. The piezo actuator may control rotation of the optic using a reverse voltage phenomenon. The piezo actuator may rotate the lens part 210 at a precise angle by applying a voltage to a sensor.

For example, one of the pair of rotary shafts 213 protruding from the rotary shaft surfaces of the micro lens 211 may be rotatably installed in the support member 223, and the other one thereof may be coupled to the driving member 221 to receive a rotational force.

In detail, one of the pair of rotary shafts 213 provided in the one lens part 210 may be connected to the piezo actuator to receive a driving force, and the other one rotary shaft 213 may be connected to the support member 223 and rotatably supported. Accordingly, the individual lens part 210 may rotate without escaping from the lens assembly 200.

However, the type of driving member 221 is not limited to the piezo actuator, and various types of driving devices may be applied as long as the driving devices may provide a driving force for rotating the lens part 210.

The controller may control the driving member 221 to individually rotate the plurality of lens modules 200a. For example, the controller may control rotation of the piezo actuator.

The support member 223 provided in one lens module 200a among the lens modules 200a adjacent to each other may be coupled to the driving member 221 provided in the other one lens module 200a.

For example, the piezo actuator may be attached to one surface of the plate-shaped support member 223. Further, the piezo actuator and the support member 223, which are formed integrally, may be disposed on both sides of the lens part 210.

Here, the support member 223 may have a shaft groove 224 into which an end of the rotary shaft 213 is inserted. An end of the rotary shaft 213 may be rotatably supported in a state of being inserted into the shaft groove 224 of the support member 223.

Hereinafter, an example in which various light distribution patterns are formed by the vehicle lamp 10 according to the embodiment of the present disclosure will be described with reference to FIGS. 6A to 7B.

First, referring to FIGS. 6A to 6C, the plurality of lens modules 200a may be divided into a plurality of areas in a vertical direction. For example, the plurality of lens modules 200a may be divided into a first area, a second area disposed under the first area, and a third area disposed under the second area.

Further, the lens assembly 200 may be provided to be switchable to any one of a first mode, a second mode, or a third mode. This control may be implemented as the driving member 221 is controlled by the controller.

The first mode may be a mode in which light incident on the lens module 200a in the first area, the second area, and the third area is provided to pass through the second optic 232, and the DRL pattern is formed by light emitted from the lens assembly 200 (see FIG. 6A).

The second mode may be a mode in which light incident on the lens module 200a in the first area is provided to pass through the second optic 232, light incident on the lens module 200a in the second area and the third area is provided to pass through the first optic 231, and a low beam pattern is formed by the light emitted from the lens assembly 200 (see FIG. 6B).

The third mode may be a mode in which the light incident on the lens module 200a in the first area, the second area, and the third area is provided to pass through the first optic 231, and a high beam pattern is formed by the light emitted from the lens assembly 200 (see FIG. 6C).

For example, a radiation distance A2 of emission light passing through the first optic 231 may be greater than a radiation distance A1 of emission light passing through the second optic 232. In other words, the light passing through the first optic 231 may reach a great distance from the lamp compared to the light passing through the second optic 232.

The DRL lamp is a lamp that is intended to improve safety of the vehicle and makes the vehicle more visible during the day so that other drivers may recognize the vehicle. The DRL is generally operated with low power, and thus in the first mode, the light incident on the lens module 200a in the first area, the second area, and the third area may be provided to pass through the second optic 232.

The low beam pattern is intended to illuminate at a low angle to identify roads and nearby obstacles well. Therefore, in the second mode, the light incident on the lens module 200a in the second area and the third area located on a lower side may be provided to pass through the first optic 231 to secure long distance radiation.

The high beam pattern is intended to illuminate at a high angle to illuminate a wider and farther area. Thus, in the third mode, the light incident on the lens module 200a in the entire area may be provided to pass through the first optic 231.

Meanwhile, referring to FIGS. 7A and 7B, in the embodiment of the present disclosure, an object sensing part (not illustrated) for sensing an object present in front of the vehicle may be further included.

Further, when receiving a sensing signal generated by sensing the object from the object sensing part, the controller may control the driving member 221 so that light incident on the lens module 200a in an area corresponding to the object passes through the first optic 231, and light incident on the lens module 200a in the other area passes through the second optic 232.

For example, as illustrated in FIG. 7A, when an object is not sensed in the front, the controller may control the driving member 221 so that light incident on the entire lens module 200a passes through the second optic 232.

Meanwhile, as illustrated in an upper view and a lower view of FIG. 7B, when an object is not sensed in the front, the controller may control the driving member 221 so that light incident on the lens module 200a in an area corresponding to the object passes through the second optic 232, and light incident on the lens module 200a in the other area passes through the first optic 231.

By this control, the vehicle lamp 10 may be driven as an ADB.

Meanwhile, the light source part 100 may be provided to be color-switchable.

For example, the light source part 100 may be connected to the controller. Further, the controller may control such that color of the light source part 100 is switched and the light source part 100 is turned on. Accordingly, the vehicle lamp 10 according to the embodiment of the present disclosure may function as a hazard flasher lamp or a turn signal lamp.

A vehicle lamp according to an embodiment of the present disclosure may have at least one of the following effects.

In the embodiment of the present disclosure, the lamp, which performs various functions without an additional separate lamp as the plurality of lens modules implemented as a surface-light emitting type are individually rotated and driven, may be implemented.

For example, according to an embodiment of the present disclosure, a lamp, which performs various functions, such as a DRL, a low beam and high beam lamp, an ADB, and a turn signal lamp may be implemented as a single vehicle lamp. Further, according to the embodiment of the present disclosure, one lamp structure may implement a plurality of functions, and thus use of an additional lamp is not required.

Although specific embodiments of the present disclosure have been described above, the spirit and scope of the present disclosure are not limited thereto, and those skilled in the art to which the present disclosure pertains may derive various modifications and changes without changing the subject matter of the present disclosure described in the appended claims.

What is claimed is:

1. A vehicle lamp comprising:
a light source part configured to generate light; and
a lens assembly including a plurality of lens modules configured to form a light distribution pattern by emitting the light radiated from the light source part to the front, the lens modules being individually rotated and driven,
wherein the lens assembly is configured to form a plurality of light distribution patterns having different characteristics by individual rotation driving of the plurality of lens modules.

2. The vehicle lamp of claim 1, wherein the plurality of lens modules are arranged in a lattice form that is repeated in a vertical direction and a horizontal direction.

3. The vehicle lamp of claim 1, wherein each of the lens modules includes:
a lens part; and
an optic part including a plurality of optics disposed on a surface of the lens part and having different optical characteristics.

4. The vehicle lamp of claim 3, wherein the lens part includes:
a micro lens; and
a pair of rotary shafts protruding from a pair of surfaces of the micro lens, which face each other,
wherein the optic part is disposed on a surface of the micro lens other than a surface from which the rotary shaft protrudes among outer surfaces of the micro lens.

5. The vehicle lamp of claim 4, wherein the micro lenses adjacent to each other share an imaginary central axis extending in a vertical direction or a horizontal direction,
wherein the rotary shafts are formed on the imaginary central axis, and
wherein the optic part surrounds an outer surface spaced apart from the imaginary central axis in a radial direction, among the outer surfaces of the micro lens.

6. The vehicle lamp of claim 4, wherein the micro lens has a hexahedral shape and includes:
a pair of rotary shaft surfaces from which the rotary shafts protrude and which face each other;
a first incidence surface that connects the pair of rotary shaft surfaces and on which light is incident;
a first emission surface facing the first incidence surface;
a second incidence surface that connects the pair of rotary shaft surfaces and on which light is incident; and
a second emission surface facing the second incidence surface.

7. The vehicle lamp of claim 6, wherein the optic part includes:
a first optic installed on the first incidence surface and the first emission surface; and
a second optic installed on the second incidence surface and the second emission surface.

8. The vehicle lamp of claim 7, wherein each of the plurality of lens modules allows the light emitted from the light source part to selectively pass through any one of the first optic and the second optic by rotation, and
wherein a light distribution pattern generated by the light passing through the first optic and a light distribution pattern generated by the light passing through the second optic have different characteristics.

9. The vehicle lamp of claim 7, wherein the first optic includes:
a (1-1)^{th} optic installed on the first incidence surface; and
a (1-2)^{th} optic installed on the first emission surface, and
wherein the second optic includes:
a (2-1)^{th} optic installed on the second incidence surface; and
a (2-2)^{th} optic installed on the second emission surface.

10. The vehicle lamp of claim 6, wherein each of the plurality of lens modules includes:
a rotation unit configured to rotate the corresponding lens module.

11. The vehicle lamp of claim 10, wherein the rotation unit includes:
a support member configured to rotatably support the lens part;
a driving member configured to provide a driving force for rotating the lens part; and
a controller configured to control the driving member so that the plurality of lens modules are individually rotated and driven.

12. The vehicle lamp of claim 11, wherein one of the pair of rotary shafts protruding from the rotary shaft surfaces of the micro lens is rotatably installed in the support member, and the other one thereof is coupled to the driving member and configured to receive a rotational force.

13. The vehicle lamp of claim 11, wherein the support member disposed in one of the lens modules adjacent to each other is coupled to the driving member disposed in the other adjacent lens module.

14. The vehicle lamp of claim 11, wherein the support member has a shaft groove into which an end of the rotary shaft is inserted.

15. The vehicle lamp of claim 11, wherein the driving member includes a piezo actuator.

16. The vehicle lamp of claim 7, wherein the plurality of lens modules are divided into a first area, a second area disposed under the first area, and a third area disposed under the second area,
wherein the lens assembly is switched to any one of a first mode, a second mode, and a third mode,
wherein the first mode is a mode in which light incident on the lens module in the first area, the second area, and the third area passes through the second optic, and a daytime running lamp pattern is formed by light emitted from the lens assembly,
wherein the second mode is a mode in which light incident on the lens module in the first area passes through the second optic, light incident on the lens module in the second area and the third area passes through the first optic, and a low beam pattern is formed by the light emitted from the lens assembly, and
wherein the third mode is a mode in which the light incident on the lens module in the first area, the second area, and the third area passes through the first optic, and a high beam pattern is formed by the light emitted from the lens assembly.

17. The vehicle lamp of claim 11, further comprising:
an object sensing part configured to sense an object present in front of a vehicle,
wherein, when receiving a sensing signal generated by sensing the object from the object sensing part, the controller is configured to control the driving member so that light incident on the lens module in an area corresponding to the object passes through the second optic, and light incident on the lens module in the other area passes through the first optic.

18. The vehicle lamp of claim 1, wherein the light source part is color-switchable.
